(19) United States
(12) Patent Application Publication
(10) Pub. No.: US 2005/0019586 A1
(43) Pub. Date: Jan. 27, 2005

(54) Forming an embossed coated substrate

(76) Inventors: Dirk Bontinck, Ertvelde (BE); Marc Colpaert, Gent (BE); Guido Vanmeulder, Rode (BE)

Correspondence Address: WENDEROTH, LIND & PONACK, L.L.P., 2033 K STREET N. W., SUITE 800, WASHINGTON, DC, 20006-1021, US

(21) Appl. No.: 10/486,732

(22) PCT Filed: Sep. 4, 2002
(86) PCT No.: PCT/EP02/09914

(30) Foreign Application Priority Data
Sep. 6, 2001 (EP) 01121346.9

(51) Int. Cl. B05D 3/02; B32B 27/00

(52) U.S. Cl. 428/423.1; 427/558; 427/372.2

(57) ABSTRACT

The invention relates to a process of forming an embossed coated substrate. The process comprises the steps of: (I) forming on a substrate at least one coating whose composition comprises a radiation-curable polyurethane dispersion, (II) embossing the coated substrate on a relief surface, (III) irradiating the embossed coated substrate to cure the polyurethane-containing coating. An application of the process is the manufacturing of caul paper.

The present invention relates to a process of forming an embossed coated substrate.

Embossing can be defined as raising in relief a surface by various means including pressure means such as stamping, moulding or rolling.

A substrate bearing a coating may be embossed so as to transfer a grain or other texture relief on the coating. The embossed coating may be further released from the substrate if desired. This provides thus on one hand a coating or film bearing a relief and on the other hand a substrate which can be intact and reusable.

Paper or plastics based substrates in sheet or foil form are often designated by the generic term ‘paper’. Caul paper is a technical term that encompasses several type of embossing papers and casting foils. These ‘papers’ are used to transfer a functional surface texture or grain onto another substrate. Typical examples include artificial leather (polyurethane or polyvinylchloride based), furniture foils, shoes, upholstery, handbags, attach cases and suitcases.

There are three categories of embossing ‘papers’ based on the level of performance:
1. conventional coatings where release properties are obtained by silicone or fatty acid chromium complexes,
2. extruded film/paper laminates: these films are thermoplastics and are easily deformed in a heated embossing nip,
3. ULTRACAST technology: 100% acrylate resins are cured by electron beam radiation while on an embossing drum.

Curing a polymer composition may be effected by heat (known as “heat curing”) or by other radiation means (known as “radiation curing”), typically electron beam radiation or ultraviolet radiation. Radiation curing is more and more preferred since it requires less energy and allows higher production rates than heat curing. The ULTRACAST technology is using radiation curing means particularly electron-beam radiation.

Several patents filed by Scott Paper Company are describing the ULTRACAST technology: EP 0 036 883-U.S. Pat. No. 4,289,821-U.S. Pat. No. 4,322,450-U.S. Pat. No. 4,327,121-U.S. Pat. No. 4,427,732-U.S. Pat. No. 4,840,757.

The ULTRACAST technology is designed for high performance, and is the most widespread in the embossing industry.

However, this technology has a high operational cost due to the electron beam curing and, furthermore, it has a narrow application window. This can be derived from the fact that a liquid layer of a mix of acrylated monomers and oligomers must be embossed and cured at the same time, which is only possible when curing through the back of the paper to avoid sticking to the embossing roll. Therefore, only high-energy radiation curing (electron beam) can be used. Embossing and curing of the coating must be carried out at the same time because of its liquid nature before and its non-thermoplastic behaviour after curing. The result is a difficult and expensive manufacturing process.

An alternative to the ULTRACAST technology is described in EP 0 210620 A and DE 4 421 559 A: a lacquer is first precured, then embossed and fully cured later. Such manufacturing process is also difficult and expensive.

It is therefore desirable to find out an easy and flexible process of forming an embossed coated substrate. Preferably the process should be of economic use.

The present invention provides a process of forming an embossed coated substrate which comprises the steps of:
(I) forming on the substrate at least one coating whose composition comprises a radiation-curable polyurethane dispersion,
(II) embossing the coated substrate on a relief surface,
(III) irradiating the embossed coated substrate to cure the polyurethane-containing coating.

We have surprisingly found that the objectives of easiness and flexibility can be met if a radiation-curable polyurethane dispersion is used to form the coating on the substrate.

Radiation-curable polyurethane dispersions are typically made starting with an anionic, isocyanate-terminated polyurethane prepolymer, which is reacted with an hydroxylated acrylate. The reacted prepolymer is then dispersed into water using a tertiary amine as a neutralizing agent for the carboxylate functions. The dispersion obtained is substantially tack-free before curing.

This feature enables to separate the embossing and curing operations in time and place. This permits to obtain a flexible, versatile manufacturing process.

For example, this is very interesting for the manufacturing of caul paper: the surface of the coating can be embossed before curing, without sticking to the relief surface of the embossing means (often an embossing roll). If appropriate, the curing step can be carried out off-line, since the uncured coating on the casting foil does not stick to the back side of the foil. If necessary, the uncured paper can even be wound up and cured with radiation at another time or at another place.

Furthermore, the radiation-curable polyurethane dispersions can be formulated to a broad range of gloss values. Then the final gloss of the coating is not linked to the embossing surface. In practice, this means that with one and the same embossing surface, different gloss levels can be obtained.

As gloss, thickness and surface embossing can be arranged for on the same coating equipment, the present invention results in a high degree of freedom in both process and design.

Preferably the coating is dried between step (I) and (II). Thus the coating is dried before embossing. Such drying contributes to the desired low surface tackiness of the uncured coating and greatly decreases the risk of sticking to the embossing surface.

Preferably the drying temperature is comprised between 60 and 120° C. and/or the drying time is comprised between 30 seconds and 5 minutes. It was found that such temperature/time range permits to obtain a favourable compromise between the requirements of process speed, no or low degree of coating tackiness, and low risk of deterioration of the uncured coating.

Embossing the coated substrate can be made by different means such as moulding or clamping equipment. However it is preferred to emboss the coated substrate by contact with a relief surface of a roller. This is a practical and low cost manner to emboss the coating, and well adapted to large scale production.

Preferably the embossement step is carried out with one or more of the following characteristics:
embossing temperature comprised between 60 and 220° C.,
embossing time comprised between 1 and 20 seconds
embossing the coated substrate with a pressure comprised between 5 and 30 kg/cm2.

These characteristics were found suitable to provide a quick and efficient embossing of the coating.

Preferably, two coatings of different composition are applied on the substrate. This contributes to the versatility of the process and permits to adapt the properties of the whole coating to the desired application.

For example, the coating needs to be thermoplastic so to be able to be correctly embossed in the embossing step. On the other hand, if the coating is to be transferred to another substrate, as it is preferred, this coating must be hard enough to ensure accurate release and transfer to another substrate, without loosing the relief of the coating.

Preferably, the upper coating of the at least two coatings has a greater hardness than the lower coating. The lower coating should be flexible enough to be accurately embossed while the upper coating should be hard enough so as to ensure accurate release and transfer of the coating to the fabric.

Preferably, the upper coating of the least two coatings has a composition containing a silicone additive, preferably an acrylated silicone additive. Such additive permits to obtain a good release and transfer of the coating.

Irradiation to cure the coating can be electron beam irradiation. However, it is preferred that irradiation of the coating is made with ultraviolet radiation. The latter is easier and less expensive than electron beam irradiation.

Preferably, during an ulterior step of the process, the embossed coating is released from the substrate. More preferably, the embossed coating is released from the substrate and transferred to another substrate. This permits to obtain a wide range of products such as fashion leather apparel, shoe uppers, handbags and other accessories.

The present invention also extends to an embossed coated substrate comprising a substrate bearing an embossed coating whose composition comprises a radiation-curable polyurethane dispersion.

Such embossed coated substrate is an interesting intermediary product. It comprises an embossed coating which can be radiation-cured in another time and place. This is because of the chemical nature of the coating whose composition comprises a radiation-curable polyurethane dispersion. Such dispersion is substantially tack-free before cure thus allowing for stocking, handling of the intermediary product. The intermediary product may even be transported to another plant to effect the final curing of the coating.

### EXAMPLES

1. Preparation of UV-PUD #1 to #4:

(Where UV-PUD Means Ultraviolet-Polyurethane Dispersion)

### UV-PUD #1

### Example 1

213.0 g of a neopentyl glycol polyadipate having a hydroxyl value of 167.5 mg KOH/g, 59.7 g of 2,2-dimethylolpropionic acid, 27.5 g of 1,4-cyclohexyl dimethanol, 399.9 g of 1,1′-bis(4-isocyanatocyclohexyl) methane and 300.0 g of acetone are introduced into a 4-liter four-necked round-bottomed flask equipped with a mechanical stirrer, a thermometer, an air condenser, and a dropping funnel. The mixture is heated at 65° C. with stirring and 0.08 g of dibutyltin dilaurate is added as a catalyst. The mixture is maintained at 65° C. for 4-5 hours, at which point an isocyanate content of 1.14 meq/g is reached. Then, 335.0 g of IRR 291 (a trifunctional polyol acrylate from UCB Chemicals, having a hydroxyl value of 70 mg KOH/g and an acid value of <5 mg KOH/g) and 0.5 g of hydroquinone monomethylether are added while the reaction mixture is further heated at 60° C. until the isocyanate content has dropped under 0.40 meq/g.

The mixture is cooled to 45° C. at which point 40.0 g of acetone and 43.5 g of triethyl amine are added while stirring. Subsequently 2292.8 g of demineralized water is added.

After evaporating the acetone under reduced pressure, a 36.0% solids aqueous dispersion with a Brookfield viscosity of 34 cPs, a pH of 7.1 and an average particle size of 56 nin is obtained.

UV-PUD#2

### Example 2

159.8 g of a neopentyl glycol polyadipate having a hydroxyl value of 167.5 mg KOH/g, 44.8 g of 2,2-dimethylolpropionic acid, 20.6 g of 1,4-cyclohexyl dimethanol, 299.8 g of 1,1′-bis(4-isocyanatocyclohexyl) methane and 225.0 g of acetone are introduced into a 4-liter four-necked round-bottomed flask equipped with a mechanical stirrer, a thermometer, an air condenser, and a dropping funnel. The mixture is heated at 65° C. with stirring and 0.08 g of dibutyltin dilaurate is added as a catalyst. The mixture is maintained at 65° C. for 4-5 hours, at which point an isocyanate content of 1.14 meq/g is reached. Then, 254.8 g of pentaerythritol triacrylate (having a hydroxyl value of 115 mg KOH/g and an acid value of <5 mg KOH/g) and 0.5 g of hydroquinone monomethylether are added while the reaction mixture is further heated at 60° C. until the isocyanate content has dropped under 0.40 meq/g.

The mixture is cooled to 45° C. at which point 40.0 g of acetone and 33.7 g of triethyl amine are added while stirring. Subsequently 1785.8 g of demineralized water is added.

After evaporating the acetone under reduced pressure, a 36.3% solids aqueous dispersion with a Brookfield viscosity of 29 cPs, a pH of 7.1 and an average particle size of 51 nm is obtained.

UV-PUD #3

### Example 3

195.0 g of Ebecryl 1290 (a urethane acrylate oligomer from UCB Chemicals) and 60.0 g of acetone are added to 1044.8 g of the diluted acrylated prepolymer obtained in example 2 (UV-PUD #2) The mixture is cooled to 45° C. at which point 33.7 g of triethyl amine are added while stirring. Subsequently 1590.9 g of demineralized water is added.

A 40.0% solids aqueous dispersion with a Brookfield viscosity of 45 cPs, a pH of 7.2 and an average particle size of 85 nm is obtained.

UV-PUD#4

### Example 4

36.4 g of IRR 154 (a silicone acrylate oligomer from UCB Chemicals) is added to 1239.8 g of the diluted acrylated prepolymer obtained in example 3 (UV-PUD#3). (containing 195.0 g of Ebecryl 1290 from UCB Chemicals). The mixture is cooled to 45° C. at which point 33.7 g of triethyl amine are added while stirring. Subsequently 1590.9 g of demineralized water is added.

A 42.5% solids aqueous dispersion with a Brookfield viscosity of 85 cPs, a pH of 7.1 and an average particle size of 91 nm is obtained.

The characteristics of the UV-PUD products prepared are as follows:

TABLE 1
Characterization of UV-PUD #1 to #4

| | UV-PUD | UV-PUD | UV-PUD | UV-PUD |
|---|---|---|---|---|
| | #1 | #2 | #3 | #4 |
| meq. Acrylic/g of | 1.91 | 3.29 | 3.93 | 3.89 |
| solids | | | | |
| Approx. Mn | 15,000 | 12,000 | 8,000 | 8,000 |
| % solids | 36.0 | 36.3 | 40.0 | 42.5 |
| Mean Av. part. size | 56 | 51 | 85 | 91 |
| (nm) | | | | |
| pH | 7.1 | 7.1 | 7.2 | 7.1 |
| Brookfield Viscosity | 34 | 29 | 45 | 85 |
| 25° C. at 50 RPM | | | | |
| (mPa · s) | | | | |
| Isocyanate | Aliphatic | Aliphatic | Aliphatic | Aliphatic |
| Polyol | Polyester | Polyester | Polyester | Polyester |

It can be seen in Table 1 that UV-PUD products having various molecular weight and various acrylic content were used.

A cured coating becomes harder and more rigid as the number of acrylic double bonds increases. The chemical and solvent resistance is generally increasing accordingly to the rigidity and hardness of the cured coating. The molecular weight between crosslinks and the crosslink density has also an effect on the flexibility of the cured coating.

2. General Formulation for Waterborne UV-PUD

A typical formulation for waterborne UV-PUD is shown in Table 2.

TABLE 2

| | Supplier | Parts |
|---|---|---|
| UV-PUD | UCB | 100.0 |
| TS100 | Degussa | 1.0 |
| Byk 346 | Byk | 1.0 |
| Byk 028 | Byk | 0.5 |
| Irgacure 500 | Ciba | 1.5 |
| Ucecoat XE430 | UCB | 0.7 |

Next to the binder itself, a matting agent, a wetting agent, a wax, a photo-initiator and a Theological modifier are being used. This formulation results in a Brookfield viscosity of 1000 mpa.s and a 60° gloss of 25%.

Application on paper is preferably done by roller coating in reverse mode. Flash-off for a 90 g/m² wet coating is achieved in 1 minute at 80° C. Curing is carried out with two Hg-lamps at 80 W/cm, at a typical line speed of 10 m per minute.

3. Embossing

Several UV-PUD, differing in UV-crosslinking density and hence coating hardness, were coated on a 150 g/m² type of paper. Typically, 90 g/m² of wet UV-PUD was applied, yielding 30 g/m² of dry coating after drying at 80° C. for 1 minute. All coatings represented in Table 3 showed to be tack-free after water flash-off: wiping the surface with talc and cotton-wool leaves no trace of talc particles

The embossing is carried out at 150° C. for 4 seconds with a pressure of 14 kg/cm². According to the degree of tackiness at 150° C., related to the molecular weight before

UV-curing, embossing is poor (lower molecular weight) to OK for the highest molecular weight UV-PUD #1. After embossing, all caul paper samples could be wound or stacked without any sticking or loss of definition at room temperature. UV-curing can be carried out at any given time, either on-line or after transportation to a UV-line.

TABLE 3
Embossing performance of UV-PUD

| | Approx. Mn | Embossing |
|---|---|---|
| UV-PUD #1 | 15,000 | OK |
| UV-PUD #2 | 12,000 | Acceptable |
| UV-PUD #3 | 8,000 | Poor |

4. Release

This caul paper property is perhaps the most important one; the affinity and adhesion towards the embossed coating should be as low as possible. The caul paper needs to be ‘hard’ enough to ensure fast and correct release of the applied coating during the image transfer process.

Since in practice, the transfer is carried out immediately after ‘water flash-off’ the applied coating, temperatures can be as high as 150° C. It was found that only the hard, densely UV-crosslinked PUD (#3) is temperature resistant enough (no softening) to ensure a correct release at 150° C. The relative release performance of the UV-crosslinked PUD is represented in Table 4, and reflects the easiness with which the dried coating can be torn from the paper.

TABLE 4
Release performance of UV-PUD

| | Release | Release |
|---|---|---|
| | (100° C.) | (150° C.) |
| UV-PUD #1 | Borderline | Impossible |
| UV-PUD #2 | OK | Very difficult |
| UV-PUD #3 | OK | Difficult |

The surface tack of UV-PUD #3 can be decreased using silicones for easy release. Table 5 reveals that silicone gum Add51 (Dow Corning) is particularly suited to improve the release properties of UV-PUD #3 coated caul paper. However, after 3 days, all silicone additives had migrated to the surface and were eventually removed during the coating process, again resulting in difficult release behaviour at higher temperatures. It was found that the incorporation of 2.5% of a silicone modified urethane acrylate (IRR 154 from UCB Chemicals) into UV-PUD #3 (combination shown as UV-PUD #4), during UV-irradiation, provides the necessary reduction of surface tack without risk of migration.

TABLE 5
Silicone modifications of UV-PUD #3

| | | | Release | |
|---|---|---|---|---|
| | Supplier | parts | (150° C.) | Migration |
| UV-PUD #3 | UCB | 100 | Difficult | — |
| +Byk 333 | Byk | 0.2 | Difficult | No |
| +Byk 306 | Byk | 0.2 | Difficult | No |
| +Byk 307 | Byk | 0.2 | Difficult | No |
| +Add 51 | Dow Corning | 2.0 | Difficult | Yes |
| +Add 51 | Dow Corning | 5.0 | OK | Yes |
| +Add 51 | Dow Corning | 10.0 | OK | Yes |
| UV-PUD #4 | UCB | 100 | Excellent | No |

5. Solvent Resistance

In order to avoid the attack of the caul paper by solvents during the application of the top coat in a transfer coating process, solvent resistance is of paramount importance. The lifecycle time of the paper is greatly influenced by its resistance to solvents.

All UV-PUD described in this paper were found to be resistant to toluene, isopropanol and dimethylformamide. These as the most aggressive solvents used in transfer coating. Table 6 shows the solvent resistance results after 5 cycles of transfer coating using typical solvent based polyurethanes (Ucecoat FN 301 and Ucecoat TCM from UCB Chemicals) on the same sample of caul paper. None of the UV-PUD showed any damage to the embossed texture of the paper; gloss and detail were not affected. The caul papers with the highest UV-crosslinking density however showed less softening by the solvents.

TABLE 6
Solvent resistance of UV-PUD caul paper

| 5 Transfer cycles | Ucecoat TCM | Ucecoat FN301 |
|---|---|---|
| (Solvent) | (DMF) | (Toluene/IPA) |
| UV-PUD #1 | OK | OK |
| UV-PUD #2 | OK | OK |
| UV-PUD #3 | Excellent | Excellent |
| UV-PUD #4 | Excellent | Excellent |

6. Multilayer UV-PUD Caul Paper

Using a softer, less UV-croslinked PUD main coat (UV-PUD # 1) and a thin finish of a harder, more densely UV-crosslinked PUD, a caul paper exhibiting both properties (thermoplasticity for the embossing step and hardness for the correct release after transfer coating) can be made. Table 7 describes the composition of the multilayer UV-PUD caul paper.

TABLE 7
Multilayer UV-PUD caul paper

| | | | Release |
|---|---|---|---|
| 1st Layer | 2nd Layer | Embossing | (150° C.) |
| 30 g/m² of #1 | | OK | Poor |
| 30 g/m² of #4 | | Poor | OK |
| 20 g/m² of #1 | 10 g/m² of #4 | OK | OK |

7. Gloss

Since UV-PUD can be formulated into a wide gloss range, the resulting paper gloss level is independent from the embossing roll.

In Table 8, it is shown that a 60° gloss range between 10 and 80% is accessible.

TABLE 8
Gloss as a function of flattening agent (2nd layer)

| 1st Layer | 2nd Layer | OK 412 (%) | 60° Gloss |
|---|---|---|---|
| (dry matter) | (dry matter) | (Degussa) | (%) |
| 20 g/m² of #1 | 10 g/m² of #4 | 0 | 80 |
| 20 g/m² of #1 | 10 g/m² of #4 | 2 | 10 |

1. Process of forming an embossed coated substrate comprising the steps of:
(I) forming on a substrate at least one coating whose composition comprises a radiation-curable polyurethane dispersion,
(II) embossing the coated substrate on a relief surface,
(III) irradiating the embossed coated substrate to cure the polyurethane-containing coating.

2. Process according to claim 1, comprising drying the coating between step (I) and (II).

3. Process according to claim 2, comprising drying the coating at a temperature comprised between 60 and 120° C.

4. Process according to claim 2, comprising drying the coating during 30 seconds to 5 minutes.

5. Process according to claim 1, comprising embossing the coated substrate by contact with a relief surface of a roller.

6. Process according to claim 1, comprising embossing the coated substrate at a temperature comprised between 60 and 220° C.

7. Process according to claim 1, comprising embossing the coated substrate during 1 to 20 seconds.

8. Process according to claim 1, comprising embossing the coated substrate with a pressure comprised between 5 and 30 kg/cm2.

9. Process according to claim 1, comprising forming on the substrate at least two coatings of different composition.

10. Process according to claim 9, wherein the upper coating of the least two coatings has a composition containing a silicone additive, preferably an acrylated silicone additive.

11. Process according to claim 9, wherein the upper coating of the least two coatings has a greater hardness than the lower coating.

12. Process according to claim 1, wherein irradiation is made with ultraviolet radiation.

13. Process according to claim 1, comprising an ulterior step of releasing the embossed coating from the substrate.

14. Process according to claim 1, wherein the embossed coating is released from the substrate and transfered to another substrate.

15. Embossed coated substrate comprising a substrate bearing an embossed coating whose composition comprises a radiation-curable polyurethane dispersion.
